(19) United States
(12) Patent Application Publication
(10) Pub. No.: US 2021/0103286 A1
(43) Pub. Date: Apr. 8, 2021

(54) SYSTEMS AND METHODS FOR ADAPTIVE PATH PLANNING

(71) Applicant: Hong Kong Applied Science and Technology Research Institute Co., Ltd., Shatin (HK)

(72) Inventors: Binyu Wang, Shenzhen (HK); Ho Pong Sze, Ma On Shan (HK); Laifa Fang, Shenzhen (HK)

(21) Appl. No.: 16/593,592

(22) Filed: Oct. 4, 2019

(51) Int. Cl. G05D 1/02; G05D 1/00

(52) U.S. Cl. CPC G05D 1/0214; G05D 1/0088; G05D 2201/0216; G05D 1/027; G05D 1/0274; G05D 1/0221

(57) ABSTRACT

Systems and methods providing adaptive path planning techniques utilizing localized learning with global planning are described. The adaptive path planning of embodiments provides global guidance and performs local planning based on localized learning, wherein the global guidance provides a planned path through the dynamic environment from a start location to a selected destination while the local planning provides for dynamic interaction within the environment in reaching the destination, such as in response to obstacles entering the planned path. Global guidance may combine an initial global path with history information for providing a global path configured to avoid points of frequent traffic conflicts. Local planning may utilize localized deep reinforcement learning to direct interactions of an automated vehicle traversing the global path in a dynamic environment, such as in response to obstacles entering the global path. Sequential localized maps may be generated for deep learning models utilized by localized training techniques.

### TECHNICAL FIELD

The present invention relates generally to adaptive path planning and, more particularly, to adaptive path planning techniques utilizing localized learning with global planning.

### BACKGROUND OF THE INVENTION

Various forms of automated vehicles (AVs) are becoming more and more prevalent in today's world. For example, AVs in the form of self-piloted cars, robotic delivery vehicles, and automated guided vehicles (AGVs) used in warehouses and factories are not uncommon, if not in wide use, throughout industrialized nations.

Path planning, also known as path finding, algorithms are typically used with respect to AVs for their navigation to a desired destination. The popular path planning methods implement static searching algorithms, such as Dijkstra (see e.g., “A note on two problems in connexion with graphs” Numerische Mathematik. 1:269-271, Dijkstra, E., the disclosure of which is incorporated herein by reference) and A* (see e.g., “A Formal Basis for the Heuristic Determination of Minimum Cost Paths” IEEE Transactions on Systems Science and Cybernetics SSC4. 4 (2): 100-107. Hart, P. E.; Nilsson, N. J.; Raphael, B., the disclosure of which is incorporated herein by reference). Such static searching algorithms are useful in arriving at an optimal path in a static environment.

AVs, however, may operate in a multivehicle and dynamic environment (e.g., warehouse, factory, or city street grid where other AVs are operating, non-automated vehicles are being operated, humans and other autonomous biologicals are interacting, etc.). The nature of these dynamic environments can cause AVs to become impeded by unknown obstacles when they are executing operation along a planned path. This delay causes any a pre-planning to become obsolete as the interaction of AVs may cause deadlocks, and time-critical tasks become at risk for completion.

Existing path planning methods implementing static searching algorithms require repeated re-planning in dynamic environment to address conflicts with obstacles, such as other AVs in their path. Such repeated re-planning, however, comes at a high computational cost and can require appreciable computation time resulting in delays in performing the tasks. The A* approach to path planning is ineffective with respect to multiple target nodes (e.g., multiple other AVs operating in the environment) and requires a good heuristic function for effective path planning. The computation cost for the Dijkstra approach to path planning is much higher compared to that of the A* approach.

A coordinated approached has been used in constraining robots to defined roadmaps resulting in a complete and relatively fast solution for path planning that can avoid conflicts as between the AVs that are the subject of the coordination. For example, a near-optimal multivehicle approach for non-holonomic vehicles may focus on continuous curve paths that avoid moving obstacles. The problem consideration in such a coordinated approach, however, is not broad enough to be directly viable for use within complex dynamic environments, such as the aforementioned warehouse, factory, or city street grid.

Learning based algorithms, such as the deep and reinforcement learning-based real-time online path planning method (see e.g., Chinese patent publication number CN106970615A, the disclosure of which is incorporated herein by reference) and reinforcement learning with A* and a deep heuristic (see e.g., “Reinforcement Learning with A* and a Deep Heuristic” arXiv 19 Nov. 2018, https://arxiv.org/abs/1811.07745, Kesleman, A.; Ten, S.; Ghazali, A; Jubeh, M, the disclosure of which is incorporated herein by reference), have been proposed for path planning. These learning based algorithms, however, have not provided an adequate solution with respect to path planning for complex, dynamic environments. For example, the deep and reinforcement learning-based real-time online path planning approach does not generalize well to very large environments and experiences poor performance in complex environments. The reinforcement learning with A* and a deep heuristic approach also experiences poor performance in complex environments.

### BRIEF SUMMARY OF THE INVENTION

The present invention is directed to systems and methods which provide adaptive path planning techniques utilizing localized learning with global planning. Localized learning with global planning adaptive path planning according to embodiments of the invention provides efficient paths dynamically, avoiding points of frequent traffic conflicts, at relatively a low computation cost. Operation according to an adaptive path planning technique of the present invention, wherein localized learning with global planning is utilized, dynamically determines a path that can arrive at a selected destination efficiently (e.g., with respect to travel distance and computation cost) while avoiding frequent traffic conflicts. Such adaptive path planning techniques are well suited for complex, multivehicle, dynamic environments (e.g., warehouse, factory, or city street grid where a large number of other AVs and other obstacles, moving and static, are operating).

Adaptive path planning utilizing local learning with global planning according to embodiments of the invention operates to provide global guidance and perform local planning based on localized learning. In operation according to embodiments, the global guidance provides a planned path through a dynamic environment from a start location to a selected destination while the local planning provides for dynamic interaction within the dynamic environment in reaching the destination, such as in response to obstacles entering the planned path.

Global guidance provided according to embodiments implements pre-planning to provide an initial global path, and combines this pre-planning with history information for providing a global path configured to avoid points of frequent traffic conflicts. For example, a pre-planning technique implemented in global guidance of embodiments may utilize one or more static search algorithms to generate an initial global path for use with respect to an AV operating in a dynamic environment. History information regarding traffic conflicts in the environment may be utilized to revise the initial global path so as to avoid points of frequent traffic conflicts. Accordingly, embodiments operate to combine an initial global path and history information to provide global guidance for providing primary guidance for an AV operating in a dynamic environment.

Local planning provided according to embodiments implements localized training to provide dynamic interaction within the environment. For example, localized training techniques implemented in local planning of embodiments may utilize localized deep reinforcement learning (DRL) to direct interactions of an AV traversing the global path in a dynamic environment, such as in response to obstacles entering the global path. In operation according to embodiments, sequential localized maps may be generated for deep learning models utilized by localized training techniques.

Adaptive path planning techniques utilizing localized learning with global planning in accordance with embodiments of the invention provide for adaptiveness and generality facilitating application of the techniques with respect to a variety of dynamic environments. Adaptive path planning techniques of embodiments are, for example, suitable for path planning in large dynamic environments while employing reasonable computation cost.

The foregoing has outlined rather broadly the features and technical advantages of the present disclosure in order that the detailed description that follows may be better understood. Additional features and advantages will be described hereinafter which form the subject of the claims herein. It should be appreciated by those skilled in the art that the conception and specific embodiments disclosed may be readily utilized as a basis for modifying or designing other structures for carrying out the same purposes of the present designs. It should also be realized by those skilled in the art that such equivalent constructions do not depart from the spirit and scope as set forth in the appended claims. The novel features which are believed to be characteristic of the designs disclosed herein, both as to the organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawing, in which:

FIG. 1 shows a flow diagram providing operation according to an adaptive path planning technique utilizing localized learning with global planning according to embodiments of the present invention;

FIG. 2 shows a processor-based system configured to implement adaptive path planning techniques utilizing localized learning with global planning according to embodiments of the present invention;

FIG. 3 shows an example of a dynamic environment for which an adaptive path planning technique utilizing localized learning with global planning may be implemented according to embodiments of the present invention;

FIG. 4 shows determination of an initial global path within a dynamic environment according to embodiments of the present invention;

FIG. 5 shows the use of history information with respect to an initial global path to provide a global path according to embodiments of the present invention;

FIG. 6 shows generation of sequential localized maps for deep learning models implemented by local planning logic of embodiments of the present invention;

FIG. 7 shows operation of a double deep Q learning (DDQN) function of a deep reinforcement learning (DRL) agent operating as the local path planner of embodiments of the present invention; and

FIG. 8 shows local planning operation according to embodiments of the present invention.

### DETAILED DESCRIPTION OF THE INVENTION

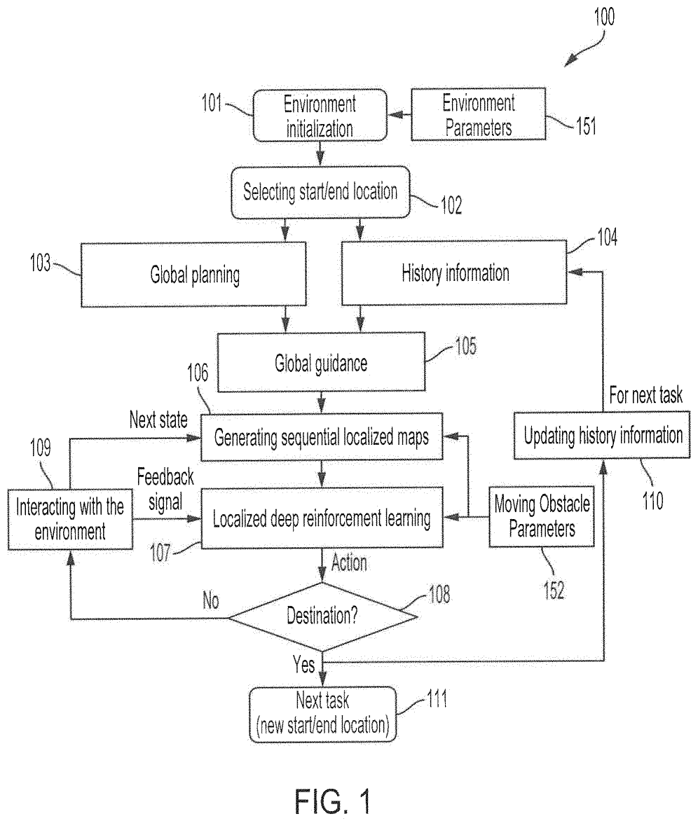

FIG. 1 shows a flow diagram providing operation according to an adaptive path planning technique utilizing localized learning with global planning according to concepts of the present invention. In particular, and as will be described in further detail below, flow 100 of FIG. 1 provides an exemplary embodiment of adaptive path planning utilizing local learning with global planning to provide global guidance and perform local planning based on localized learning. In operation according to embodiments of flow 100, a planned path through a dynamic environment from a start location to a selected destination is provided with respect to an automated vehicle (AV), such as a self-piloted car, robotic delivery vehicle, automated guided vehicle (AGV), a drone, an unmanned aerial vehicle (UAV), etc., operating in the dynamic environment. An AV for which a particular instance of path planning and/or guidance is provided by an adaptive path planning technique of embodiments of the invention may be referred to herein as an agent AV, whereas other AVs operating within the dynamic environment may be referred to as moving obstacles with respect to this particular instance of the path planning and/or guidance. Local planning implemented according to flow 100 of embodiments controls dynamic interaction of the agent AV within the environment in order facilitate its reaching the global path destination.

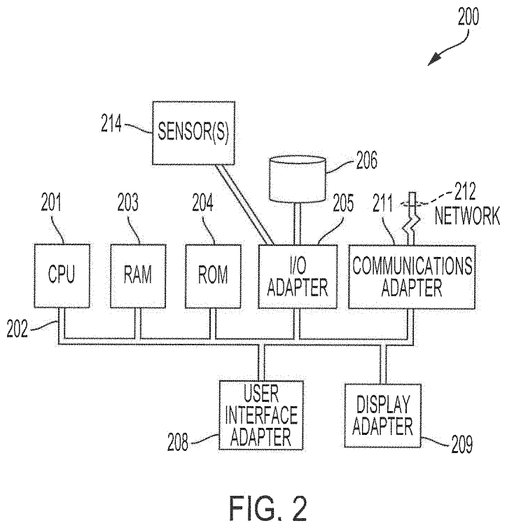

FIG. 2 shows processor-based system 200 configured to implement adaptive path planning techniques utilizing localized learning with global planning according to embodiments of the present invention. An instance of processor-based system 200 may, for example, comprise an adaptive path planning system, such as may comprise part of a controller platform for one or more agent AVs operable within a dynamic environment. For example, processor-based system 200 may comprise a control system implemented internally to an agent AV (e.g., vehicle control unit (VCU), electronic control unit (ECU), on-board computer (OBC), etc.) providing control of the AV. In accordance with some embodiments, an instance of processor-based system 200 may comprise a control system implemented externally with respect to the agent AV (e.g., server system, personal computer system, notebook computer system, tablet system, smartphone system, etc.), such as may provide control of one or more AVs. Control systems implemented internally or externally with respect to AVs are collectively referred to herein as AV controllers, wherein adaptive path planning systems may be integrated with such AV controllers. It should be appreciated, however, that adaptive path planning systems operable in accordance with the concepts herein may be implemented independently of an AV control system.

In the illustrated embodiment of processor-based system 200, central processing unit (CPU) 201 is coupled to system bus 202. CPU 201 may comprise a general purpose CPU, such as a processor from the CORE family of processors available from Intel Corporation, a processor from the ATHLON family of processors available from Advanced Micro Devices, Inc., a processor from the POWERPC family of processors available from the AIM Alliance, etc. However, the present invention is not restricted by the architecture of CPU 201 as long as CPU 201 supports the inventive operations as described herein. For example, CPU 201 of embodiments may comprise one or more special purpose processors, such as an application specific integrated circuit (ASIC), a graphics processing unit (GPU), a field programmable gate array (FPGA), etc. Bus 202 couples CPU 201 to random access memory (RAM) 203 (e.g., SRAM, DRAM, SDRAM, etc.) and ROM 204 (e.g., PROM, EPROM, EEPROM, etc.). RAM 203 and ROM 204 hold user and system data and programs, such as may comprise some or all of the aforementioned program code for performing functions of an adaptive path planning technique utilizing localized learning with global planning and data associated therewith.

Bus 202 of the illustrated embodiment of processor-based system 200 is also coupled to input/output (I/O) adapter 205, communications adapter 211, user interface adapter 208, and display adapter 209. I/O adapter 205 couples to storage device 206 (e.g., one or more of a hard drive, optical drive, solid state drive, etc.), to CPU 201 and RAM 203, such as to exchange program code for performing functions of an adaptive path planning technique utilizing localized learning with global planning and/or data associated therewith. Storage device 206 may, for example, store program code (e.g., programmatic logic) of an adaptive path planning system, data used by an adaptive path planning system, such as history information, attributes of the dynamic environment, etc. I/O adapter 205 of the illustrated embodiment also couples sensor(s) 214 (e.g., camera, proximity detector, accelerometer, microphone, rangefinder, etc.) to CPU 201 and RAM 203, such as for use with respect to the system detecting and otherwise determining the presence of obstacles and other items. I/O adaptor 205 of embodiments may additionally or alternatively providing coupling of various other devices, such as a printer (e.g., dot matrix printer, laser printer, inkjet printer, thermal printer, etc.), to facilitate desired functionality (e.g., allow the system to print paper copies of information such as planned paths, results of learning operations, and/or other information and documents). Communications adapter 211 is configured to couple processor-based system 200 to network 212 (e.g., a cellular communication network, a LAN, WAN, the Internet, etc.). Communications adapter 211 of embodiments may, for example, comprise a WiFi network adaptor, a Bluetooth interface, a cellular communication interface, a mesh network interface (e.g., ZigBee, Z-Wave, etc.), a network interface card (NIC), and/or the like. User interface adapter 208 and display adapter 209 of the illustrated embodiment may be utilized to facilitate user interaction with processor-based system 200. For example, user interface adapter 208 may couple one or more user input devices (e.g., keyboard, pointing device, touch pad, microphone, etc.) to processor-based system 200 for facilitating user input when desired. Display adapter 209 may couple one or more user output devices (e.g., flat panel display, touch screen, heads-up display, holographic projector, etc.) to processor-based system 200 for facilitating user output when desired. It should be appreciated that various ones of the foregoing functional aspects of processor-based system 200 may be included or omitted, as desired or determined to be appropriate, depending upon the specific implementation of a particular instance of the processor-based system (e.g., providing an implementation of an AV controller internal to an agent AV, providing a control system implemented externally with respect to the agent AV, etc.).

Referring again to FIG. 1, adaptive path planning technique utilizing localized learning with global planning facilitates dynamically determining a path within a dynamic environment that an agent AV can arrive at a selected destination efficiently (e.g., with respect to travel distance and computation cost) while avoiding frequent traffic conflicts within the environment. The dynamic environment may comprise any of variety of environments, such as may comprise a warehouse complex, a factory campus, a city street grid, where other AVs, non-automated vehicles, humans and other autonomous biologicals, and/or the like (e.g., moving obstacles) may be operating or otherwise interacting. In accordance with some embodiments of the invention, the dynamic environment comprises an environment in which a large number of other AVs and other obstacles, moving and static, are present. Irrespective of the particular dynamic environment in which the agent AV operates, operation at block 101 of exemplary flow 100 provides for initialization of that environment. Environment initialization logic of an adaptive path planning system implementing functions of flow 100 may, for example establish the attributes of the dynamic environment, such as using various environment parameters (e.g., environment parameters 151) for size, shape, edge locations, fixed obstacle locations, obstacle volume information (e.g., width, length, and/or height), points of interest, passage ways, passage way dimensions (e.g., width and/or length), agent task information (e.g., number of tasks for one or more agents operable within the dynamic environment), topography, morphology, etc. Environment parameters of embodiments of the invention may, for example, be provided in the form of a graph with edges and nodes, wherein the edges may define passage ways with weights to represent length or travel cost and the nodes may define the interactions between edges (e.g., where the agent can change its direction). Environment initialization according to embodiments of the invention depicts various aspects of the dynamic environment so as to provide an underlying framework (e.g., comprising a map or atlas of the dynamic environment) upon which path planning may overlay one or more paths for an AV operating within the dynamic environment.

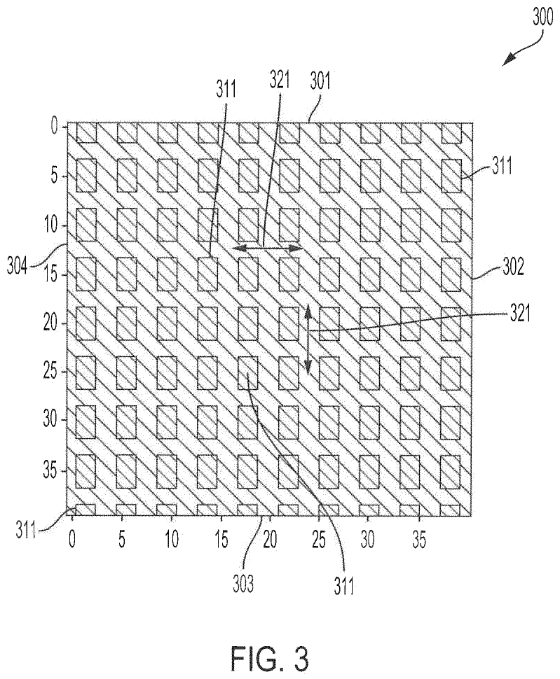

FIG. 3 illustrates an example of a dynamic environment graphically as dynamic environment 300. Environment parameters 151 of embodiments may, for example, comprise data (e.g., map) providing a graphical representation of dynamic environment 300 and/or data (e.g., various environment parameters) defining dynamic environment 300. The illustrated example of dynamic environment 300 is defined by edges 301-304 encompassing an area of the dynamic environment. Various features are shown within dynamic environment 300 of FIG. 3. For example, dynamic environment 300 includes a plurality of stationary obstacles (e.g., including shelving and walls in a warehouse, machinery, equipment, and walls in a factory, buildings, curbs, sidewalks medians, and utility infrastructure in a city street grid, etc.), ones of which being designated obstacles 311 in the illustration. Dynamic environment 300 further includes a plurality of passages (e.g., aisles, halls, and pathways in a warehouse or factory, roads, bridges, viaducts, lanes, and driveways in a city street grid, etc.), ones of which being designated passages 321 in the illustration.

The illustrated example of dynamic environment 300 shows a simplified version of a relatively regular and organized environment configuration, such as may represent a warehouse environment. It should be understood that other environment configurations, such as irregular or randomized configurations (e.g., configurations in which stationary obstacles are not regularly spaced or positioned) may be accommodated according to embodiments. Moreover, although the example dynamic environment shown in FIG. 3 is highly simplified to aid in understanding the concepts of the present invention, it can nevertheless be appreciated that aspects of configurations of such dynamic environments, including very complex dynamic environments, may be defined using parameters such as those environment parameters 151 described above with respect to environment initialization for adaptive path planning implementation.

It should be appreciated that, although dynamic environment 300 represents a dynamic environment in which AVs, non-automated vehicles, humans and other autonomous biologicals, and/or the like may be operating or otherwise interacting, information regarding such moving obstacles need not be provided as part of the environment initialization. For example, moving obstacle information may become outdated very quickly and thus be of little to no value in path planning, and thus may be collected and/or provided for use in adaptive path planning at or near a time such data is considered by operation of the adaptive path planning technique. Accordingly, environment parameters 151 of embodiments may not include information regarding moving obstacles.

Path planning with respect to an agent AV operating within the dynamic environment provides for the agent AV traversing at least some portion of the dynamic environment to arrive at a selected destination. For example, flow 100 of FIG. 1 provides adaptive path planning using localized learning with global planning to dynamically determine a path for an agent AV arriving at a selected destination efficiently while avoiding frequent traffic conflicts. To facilitate the path planning, start and/or end locations of the path for the agent AV are selected at block 102 of the illustrated of embodiment of flow 100. For example, a start location for path planning may be selected by location selection logic of an adaptive path planning system implementing functions of flow 100 from a current location of an agent AV for which path planning is to be performed, an expected location of the agent AV at a point in time when navigation of the path is to commence by the agent AV, a location at which when the agent AV eventually reaches navigation of the path is to commence by the agent AV, etc. An end location may be selected by the location selection logic of the adaptive path planning system, for example, from a desired location for the agent AV, such as for the agent AV to perform or complete a task (e.g., retrieve goods, deliver goods, manipulate an item, interact with a biological and/or other system, etc.), for performing or completing a task with respect to the agent AV (e.g., storage or maintenance of the agent AV, performing testing of one or more systems of the agent AV, etc.), for enabling another AV to perform or complete a task (e.g., to move an agent AV from the area of another AV or to place an agent AV in a position so as not to present traffic conflicts for other AVs), etc.

The adaptive path planning of flow 100 shown in FIG. 1 operates to provide global guidance and to perform local planning based on localized learning. At block 103 of the illustrated embodiment flow 100 shown in FIG. 1, global planning is implemented to determine an initial global path for use with respect to an agent AV operating within a dynamic environment. For example, a pre-planning technique may be utilized by global planning logic of an adaptive planning system implementing functions of flow 100, wherein one or more static search algorithms are utilized to generate the initial global path for an agent AV operating in dynamic environment 300. The global planning of embodiments of the present invention may use one or more static searching algorithms such as Dijkstra, A*, D*, rapidly-exploring random tree (RRT), particle swarm optimization (PSO), ant-colony, and/or the like to determine an initial global path.

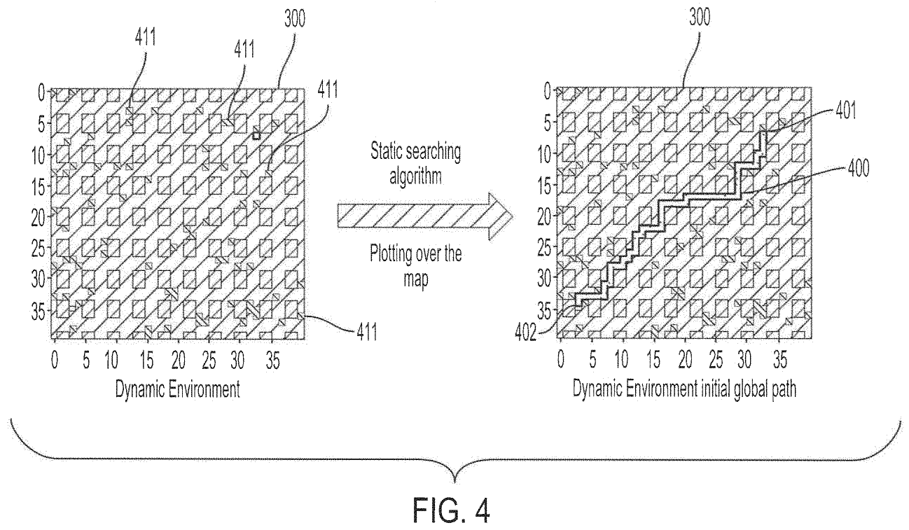

FIG. 4 illustrates determination of initial global path 400 within dynamic environment 300 according to embodiments of the invention. For example, a static searching algorithm (e.g., A*) may be utilized with respect to dynamic environment 300 (e.g., provided as environment parameters 151) to determine initial global path between start point 401 and endpoint 402 (e.g., selected at block 102). Initial global path 400 of embodiments provides an initial planned path through dynamic environment 300 from a start location to a selected destination based upon one or more static searching algorithms (e.g., an optimal path in a static environment, but not configured for a dynamic environment). Accordingly, moving obstacles (e.g., some of which are designated as moving obstacles 411 in FIG. 4) within dynamic environment are not considered during the global planning of step 103 of embodiments of the invention.

The use of initial global paths according to embodiments of the invention facilitates providing a prompt feedback for training a DRL agent (e.g., reward shaping) of the adaptive path planning technique utilizing localized learning with global planning according to concepts of the present invention. Moreover, initial global paths utilized according to embodiments of the invention speed up model convergence as an explicit attention mechanism, as well as improve the quality of the memory pool (e.g., stop training when the agent AV deviates from the guidance too much).

At block 104 of the adaptive path planning of the illustrated embodiment of flow 100 history information (e.g., as may be stored in a database of an adaptive path planning system implementing functions of flow 100) is provided for use with respect to the global guidance for the agent AV. For example, history information regarding moving obstacles within dynamic environment 300 may be identified or selected at block 104. In accordance with some embodiments, history information for portions of dynamic environment 300 likely to be traversed when navigating from the start location to the end location (e.g., history information for the areas of the dynamic environment that may include a path, or portion thereof, between the start location to the end location) may be identified or selected by history information logic of an adaptive path planning system implementing functions of flow 100 and provided for use in the global guidance of an agent AV. History information regarding prior traffic conflicts in the environment, past paths utilized by AVs in the environment in the past, etc. may, for example, be utilized to revise the initial global path provided at block 103 so as to avoid points of frequent traffic conflicts.

History information utilized according to embodiments of the invention may include one or more components. For example, a first component of the history information may include path overlay information with respect to moving obstacles within the dynamic environment. A second component of the history information may include pheromone information, such as may correspond to some or all of the path overlay information. Such components of the history information may be utilized alone or in combination according to embodiments of the invention. History information comprising such multiple components provides a dynamic representation of changing states within the dynamic environment and thus facilitates adaptive path planning in accordance with concepts of the present invention. Such history information of embodiments can provide an adaptive depiction of the entire environment useful in the global guidance provided according to the concepts herein.

Path overlay information of the history information of embodiments may include various forms of information regarding routes within the dynamic environment. In accordance with embodiments, path overlay information can include any prior knowledge that may affect the DRL agent moves. For example, path overlay information may comprise information regarding routes of moving obstacles, obstacle volume information, temporal information regarding movement, information regarding movement velocity, priority information with respect to moving obstacle movement, etc. Path overlay information of embodiments may include all known AV route grids (e.g., historical AV routes, common or likely AV routes, AV routes between historical or common start locations and end locations, AV routes meeting certain criteria such as less than a maximum threshold distance, maximum threshold changes in direction, maximum time to traverse, etc.). In initial operation of the adaptive path planning, where historical information regarding routes of the moving obstacles is unknown or underdeveloped, information regarding likely AV routes, AV routes between historical or common start locations and end locations, and/or other prospective or non-historical information may be utilized as a component of the history information.

As can be appreciated from the foregoing, path overlay information of embodiments may comprise known prior knowledge regarding the dynamic environment, such as in the form of a summary of previous information. Such path overlay information may, therefore, not accurately or adequately describe the dynamic situation of the dynamic environment, but nevertheless provides information useful in evaluating the cost of travelling within the dynamic environment (e.g., path overlay information may be used in a heuristic function of a static searching algorithm, such as A*, to modify the cost evaluation). Pheromone information of embodiments is thus further considered to describe environment dynamic information based on the observances from the agent or outside monitor. In operation according to embodiments of the invention, pheromone information is information recorded after the agents start to move within the dynamic environment, and thus is calculated with the agents' realistic moving information.

Pheromone information of the history information of embodiments may include various forms of information regarding behavior of agent AVs and/or moving obstacles with respect to the dynamic environment. For example, the pheromone information may include information regarding observed recent obstacle movement information (e.g., the pheromone information regarding a moving obstacle having traversed a particular route in the past may decay so as to be rendered inapplicable or of reduced weight as that information becomes stale). Pheromone information may, for example, correspond to various instances of path overlay information and may be accumulated independently for each moving obstacle in the dynamic environment, for example. The decay rate of the pheromone information may be established based upon the level of activity or movement within the dynamic environment. For example, the more obstacles moving within the dynamic environment and/or the more rapid the movement of obstacles within the dynamic environment, the smaller the decay time (greater decay rate) for the pheromone information of embodiments. Correspondingly, the fewer obstacles moving within the dynamic environment and/or the less rapid the movement of obstacles within the dynamic environment, the greater the decay time (lower decay rate) for the pheromone information of embodiments. In initial operation of the adaptive path planning, where pheromone information regarding moving obstacles is unknown or underdeveloped, information regarding path overlays may be utilized as the initial pheromone values.

Pheromone information of embodiments of the invention may be used to facilitate the use of relevant information in global guidance provided in accordance with concepts herein. For example, pheromone information corresponding to particular instances of path overlay information may indicate the applicability of that path overlay information in global guidance. As an example, path overlay information having decayed pheromone information (e.g., having reached a particular decay threshold, such as a particular number of seconds, minutes, hours, days, etc.) associated therewith may be ignored for global guidance planning, and possibly deleted from the history information. Correspondingly, path overlay information having un-decayed pheromone information (e.g., having not reached the aforementioned particular decay threshold) may be used for global guidance planning. Pheromone information may additionally or alternatively be utilized in making providing varying applicability of history information, such as to give weight with respect to global guidance planning to corresponding path overlay information proportional to an amount of pheromone information decay.

At block 105 of the adaptive path planning of the illustrated embodiment of flow 100 global guidance logic of an adaptive path planning system implementing functions of flow 100 utilizes an initial global path determined an agent AV operating within a dynamic environment (e.g., initial global path 400 determined at block 103) and history information for the dynamic environment (e.g., history information identified or selected at block 104) to provide a global path for use in the global guidance of an agent AV. For example, in operation at block 105 of embodiments, history information is used to adjust the initial global path, such as to facilitate avoiding frequent traffic jam areas and dead locks within the dynamic environment. Global paths provided by global guidance logic of embodiments may be utilized for providing primary guidance for an agent AV to traverse the dynamic environment from a start point to an endpoint.

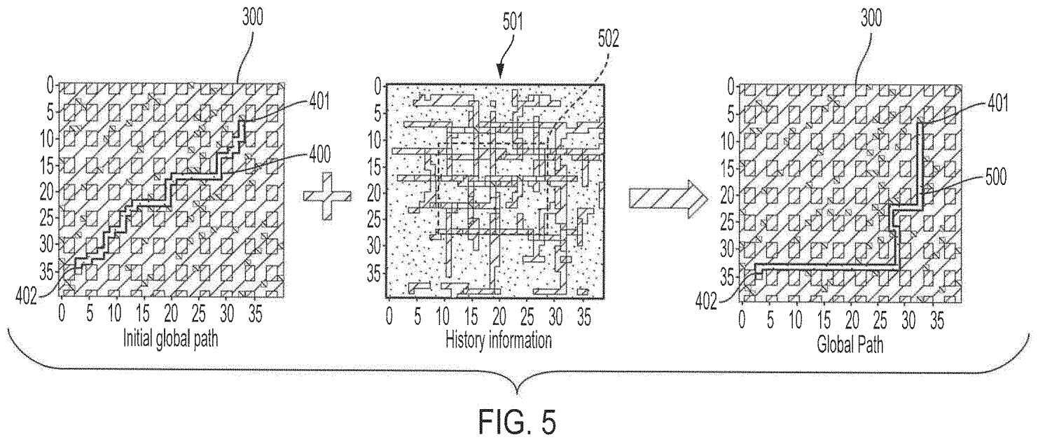

The use of history information with respect to an initial global path to provide a global path according to embodiments of the invention is illustrated in FIG. 5. For example, as shown in FIG. 5, an initial global path (e.g., initial global path 400) may be analyzed by global guidance logic in light of history information (e.g., history information 501), such as may include various components (e.g., path overlay information and pheromone information), to provide a global path (e.g., global path 500), such as may comprise the initial global path revised so as to avoid one or more points of frequent traffic conflicts as indicated by the history information (e.g., frequent traffic conflict area 502). Accordingly, the initial global path and history information are combined in the illustrated embodiment to provide a global path for providing primary guidance for an agent AV operating in a dynamic environment. In operation according to embodiments, the global path provides a planned path through the dynamic environment from a start location to a selected destination (e.g., from start point 401 to endpoint 402).

Adaptive path planning of flow 100 of embodiments of the invention implements local planning to provide for dynamic interaction within the environment to facilitate an agent AV reaching the destination. Local planning provided according to embodiments may, for example, determine and control dynamic interaction of an agent AV in response to obstacles entering the global path. Operation according to blocks 106-109 of flow 100 shown in FIG. 1 provide local planning according to embodiments of the invention.

At block 106 of the illustrated embodiment of flow 100, localized maps for use in local planning with respect to an agent AV are generated by localized map generation logic of local planning logic of an adaptive path planning system implementing functions of flow 100. In operation according to embodiments of the invention, a plurality of sequential localized maps are generated, wherein the global guidance may be plotted over the sequential localized maps. The number of sequential localized maps may be selectable according to embodiments of the invention. As an example, the number of sequential localized maps may be based on the difficulty of the task, such as to provide more localized maps to provide more temporal information with respect to a difficult task and to provide fewer localized maps with respect to a less difficult task. The difficulty of the task may, for example, be a function of the congestion of the environment, the number of nearby obstacles, the distance to the end point of the task, etc.

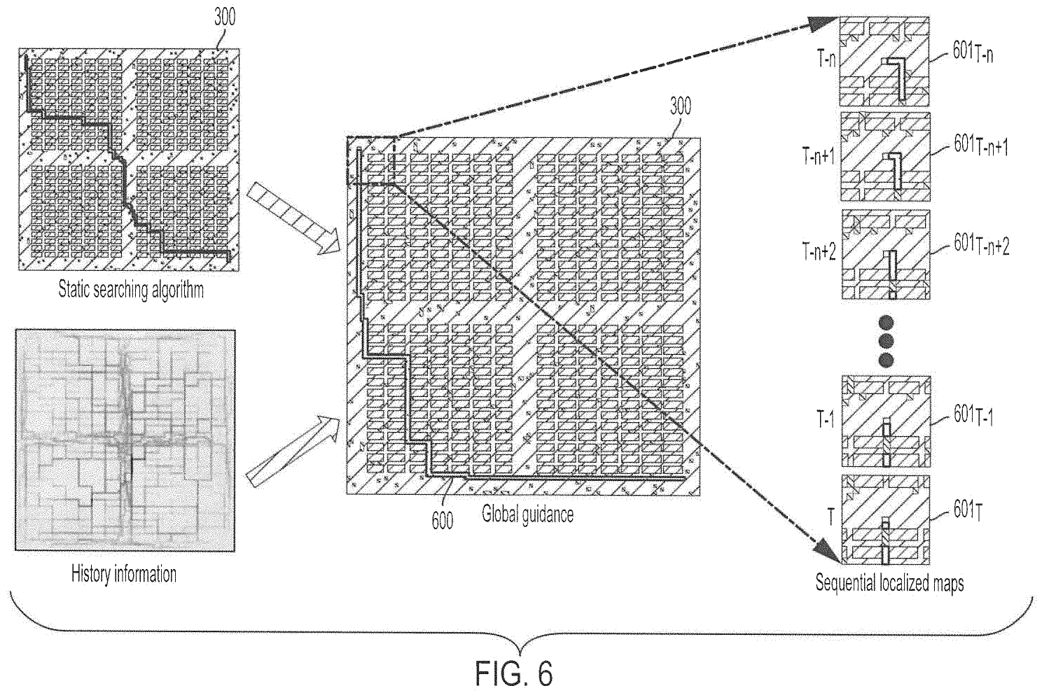

In operation according to embodiments, a global path determined for the agent AV may be plotted over the dynamic environment, as shown by global path 600 in FIG. 6 (global path 600 being another example of a global path as may be determined by the global guidance of block 105 discussed above), wherein the dynamic environment includes moving obstacle information. For example, moving obstacle parameters (e.g., moving obstacle locations, movement directions, movement speed, motion trajectory, etc.) may be detected by agent AVs and/or one or more other AVs operating within the dynamic environment, monitored by sensors on the AVs and/or otherwise present in the dynamic environment, etc. and provided as moving obstacle parameters 152 (e.g., as may be stored in a database of an adaptive path planning system implementing functions of flow 100) to the localized map generation logic. The localized map generation logic may generate localized maps with respect to an agent AV for which global guidance is being provided (e.g., localized maps centered about the agent AV) for various positions of the agent AV as the agent AV moves within the dynamic environment (e.g., traverses global path 600, or some portion thereof). Such localized maps provide a relatively small portion of the dynamic environment around the position of an agent AV suitable for use with respect to deep learning models efficiently using computing resources providing acceptable performance even in complex environments. Localized maps may, for example, be on the order of 10-30% of the area of the dynamic environment, depending upon the size of the dynamic environment, the computing resources available for local planning, the number of agent AVs and/or other moving obstacles in the dynamic environment, and the level of local planning performance desired, according to some embodiments. As an example, where the dynamic environment (e.g., dynamic environment 300) is represented with discrete grid units and comprises an area in the range of 100×100 to 300×300 grid units, localized maps may each comprise areas of 15×15 grid units (e.g., 15×15 portions of the dynamic environment centered about the agent AV). In operation according to embodiments, the size of the localized maps utilized by the local planning logic may be selectable (e.g., based on various criteria, such as the size of the dynamic environment, the computing resources available for local planning, the number of agent AVs and/or other moving obstacles in the dynamic environment, the level of local planning performance desired, etc.).

FIG. 6 illustrates generation of sequential localized maps for deep learning models implemented by local planning logic of embodiments of the invention. In particular, localized maps 601_{T-n}, 601_{T-n+1}, 601_{T-n+2}, . . . and 601_{T-1} comprise localized maps for previous positions of an agent AV within dynamic environment 300 (e.g., a sequence of positions as the agent AV traverses global path 600, or deviates from the global path when interacting with the dynamic environment) and localized map 601_{T} comprises a localized map for a current position of the agent AV within dynamic environment 300 (e.g., a current position of the agent AV on global path 600 or otherwise within dynamic environment from a deviation due to interaction with the dynamic environment). In operation according to embodiments, a localized map sequence is updated as the agent AV traverses the dynamic environment by inserting the new localized map and deleting the oldest localized map. Localized maps of the localized map sequence may, for example, be generated based on time and/or distance. As an example of time based localized map generation, 10 sequential maps may be collected at intervals of 1 second per map. As an example of distance based localized map generation, a new localized map may be generated after one step (e.g., one grid unit each step).

Local planning provided according to embodiments of the invention implements localized training to facilitate dynamic interaction within the environment. For example, localized training may learn from the behavior of moving obstacles as observed by agent AVs or otherwise as monitored in the dynamic environment and thus use this information to provide adaptive path planning with respect to the global guidance of an agent AV for dynamic interaction within the environment (e.g., in response to obstacles entering the planned path). Guidance provided by such adaptive path planning may thus be learning based guidance predicted or otherwise determined to avoid moving obstacles experienced by the agent AV and facilitate the agent AV arriving at the destination.

The localized training implemented according to the illustrated embodiment of flow 100 utilizes localized maps for an agent AV for determining dynamic interaction to be performed within the dynamic environment. For example, localized deep reinforcement learning logic of localized training logic of an adaptive path planning system implementing functions of flow 100 may utilize localized deep reinforcement learning (DRL) with respect to a modeled representation of the dynamic environment in determining actions for agent AVs within the dynamic environment. Accordingly, at block 107 of adaptive path planning of flow 100 shown in FIG. 1, localized maps generated at block 106 (possibly along with updated moving obstacle parameters 152, if available) are provided to localized deep reinforcement learning logic of the localized training logic. Localized deep reinforcement learning logic of embodiments may, for example, comprise a convolutional neural network (CNN) deep model (e.g., a three-dimensional CNN (3D CNN)) that that can act directly on the raw inputs and a recurrent neural network (RNN) model (e.g., long short term memory (LSTM)) to provide robustness against problems of long-term dependency. The localized deep reinforcement learning logic may thus use CNN and RNN to model the environment for use by a DRL agent of the localized deep reinforcement learning logic.

A DRL agent of embodiments provides a localized planner for directing interactions of an AV traversing the global path in a dynamic environment. A DRL agent implemented by localized deep reinforcement learning logic of embodiments may comprise logic for implementing various DRL methods, such as value-based DRL methods, policy based DRL methods, actor-critic methods, etc. In accordance with an exemplary embodiment, double deep Q learning (DDQN) may be implemented by DRL agent, wherein Q learning approximates the optimal action-value function Q(s, a) with ϵ-greedy. In particular, original Q learning may be represented as:

Q(s, a)=r(s, a)+γmaxₐQ(s′, a) (1)

where Q(s, a) represents the Q target, r(s, a) represents the reward of taking that action at that state, and γmaxₐQ(s′, a) represents the discounted max q value among all possible actions from the state. The generality of Q learning for complex tasks is improved in deep Q learning (DQN) using a neural network to replace the traditional Q-table. In DDQN, the target is fixed with another neural network. Double Q learning may thus be represented as:

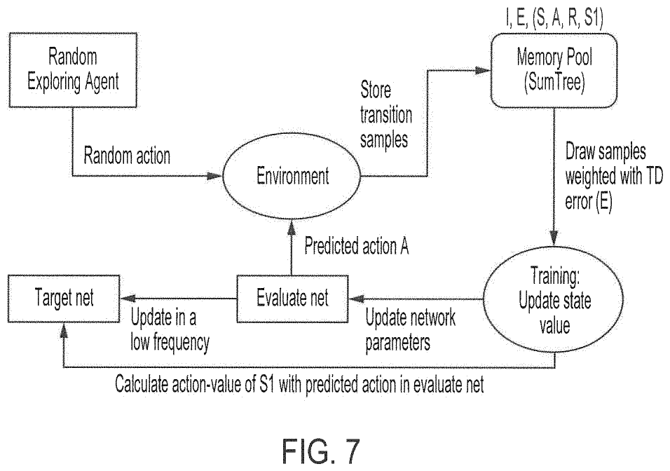

Q(s, a)=r(s, a)+γQ(s′, argmaxₐQ(s′, a)) (2)

where Q(s, a) is the TD (temporal difference) target, r(s, a) represents the reward of taking that action at that state, argmaxₐQ(s′, a) is the DQN network choose action for next state, and γQ(s′, argmaxₐQ(s′, a)) is the Q value of taking that action at that state calculated by the target network. In operation according to embodiments of the invention, a DDQN function of the DRL agent acts as the local path planner, based upon the dynamic environment model derived from the localized maps, to achieve adaptive planning. FIG. 7 graphically illustrates operation of a DDQN function of a DRL agent operating as the local path planner of embodiments of the invention.

Embodiments of the invention may utilize one or more techniques to minimize or reduce the utilization of various of the computing resources. For example, Prioritized Experience Replay (PER) may be implemented in order to utilize memory of the adaptive path planning system wisely based on TD error (e.g., some experiences may be more important than others for our training, and priority may be based on the calculated TD error).

As mentioned above, deep reinforcement learning of localized learning logic of embodiments of the invention is not limited to a DRL agent implementing DDQN. Embodiments of the invention may additionally or alternatively utilize Rainbow, Proximal Policy Optimization (PPO), Asynchronous Advantage Actor Critic (A3C), and/or like techniques with respect to a DRL agent providing local path planning. The deep reinforcement learning technique(s) utilized by a DRL agent with respect to an agent AV may be selectable according to embodiments of the invention (e.g., based on training time, computation resources, expected training performance, the size of the map, etc.).

It should be appreciated from the foregoing that localized deep reinforcement learning logic of embodiments may accept sequential localized maps as input and output the next action for an agent AV. Accordingly, the localized deep reinforcement learning logic of embodiments may provide information to control a next action (e.g., proceed on the global path, take action to deviate from the global path in response to obstacles entering the planned path, suspend movement when a conflict with a moving obstacle has been detected, return to the global path after a conflict with a moving obstacle has been avoided, restart movement when a conflict with a moving obstacle has been avoided, etc.) to control logic of an agent AV (e.g., a sub-process of a VCU, ECU, OBC, etc. controlling interaction of the agent AV within the dynamic environment) and, in response, the agent AV may implement the next action within the dynamic environment.

In operation according to embodiments, the dynamic environment receives the agent AV's action and a next state is generated. Accordingly, at block 108 of flow 100 shown in FIG. 1 a determination is made regarding whether the action taken by the agent AV has resulted in the agent AV having arrived at the destination (e.g., the agent AV has successfully navigated from start point 401 to endpoint 402).

As discussed above with respect to embodiments of a DRL agent providing a localized planner, a reward function may be used to evaluate the agent AV's action based on feedback regarding the interaction of the agent AV with the dynamic environment. Accordingly, if it is determined at block 108 that the agent AV has not arrived at the destination (e.g., global guidance with respect to the particular AV task is ongoing), processing according to the illustrated embodiment of the adaptive path planning of flow 100 proceeds to block 109 wherein environment interaction logic of an adaptive path planning system implementing functions of flow 100 may monitor the interaction of the agent AV with the dynamic environment. For example, environment interaction logic of embodiments may analyze the interaction of the agent AV with the environment to determine if conflicts with obstacles were experienced or avoided, the magnitude of a diversion from the planned global path utilized to avoid a conflict, etc., and provide feedback based upon this analysis to the localized deep reinforcement learning logic of the localized training logic. Additionally or alternatively, environment interaction logic of embodiments may analyze the interaction of the agent AV with the environment to determine the state of the agent AV and/or dynamic environment after the agent AV action, and provide state information based upon this analysis to the localized map generation logic of the local planning logic.

If it is determined at block 108 that the agent AV has arrived at the destination (e.g., global guidance with respect to the particular agent AV task has completed), processing according to the illustrated embodiment of flow 100 provides for updating the history information at block 110. For example, the path overlay information of the history information may be updated to include information regarding the global path planned for the agent AV, the actual path (e.g., including deviations from the planned global path) taken by the agent AV, the paths (or portions thereof) of moving obstacles detected by the agent AV or otherwise monitored in the dedicated environment, etc. Additionally or alternatively, pheromone information of the history information may be updated, such as to set or reset decay information (e.g., pheromone information with respect to the global path planned for the agent AV, the actual path taken by the agent AV, the paths of moving obstacles detected by the agent AV or otherwise monitored in the dedicated environment, etc.). Accordingly, after completing a first global guidance task with respect to the dynamic environment, the history information may be updated with pheromone for use with respect to subsequent tasks in the dynamic environment.

Having determined that the agent AV has arrived at the destination at block 108, processing according to flow 100 shown in FIG. 1 proceeds to block 111 wherein global guidance with respect to a next task for the agent AV may be provided. For example, operation according to block 111 may return processing to block 102 for selecting start and/or end locations of the path for an agent AV with respect to a next task.

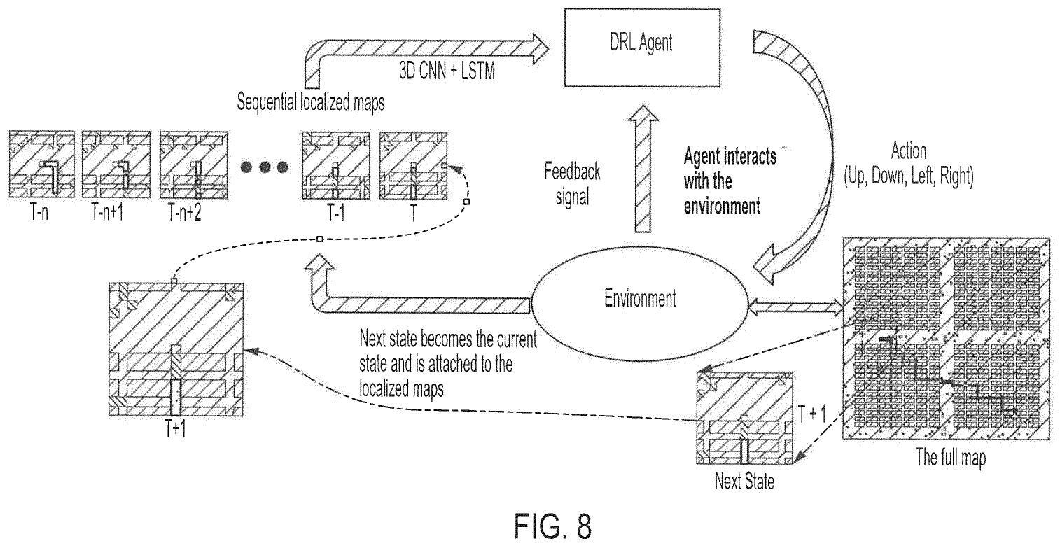

FIG. 8 graphically illustrates local planning operation according to blocks 106-109 of flow 100 consistent with examples given above. As can be seen in the diagram of FIG. 8, the local planning of the illustrated example determines and controls dynamic interaction of an agent AV in the dynamic environment.

As can be appreciated from the foregoing, embodiments of the present invention provide for adaptive path planning in a dynamic environment (e.g., a multivehicle environment, such as a warehouse, factory, city street grid or other environment in which multiple moving obstacles are present). In operation according to embodiments, the adaptive path planning may implement global guidance by defining a start and a destination, planning a path connecting the start and the destination by static searching algorithm, and generating a global guidance which is the path adjusted by combining a history information. The adaptive path planning may thereafter implement local planning to provide dynamic interaction within the dynamic environment by generating localized map sequences (e.g., T, T-1 . . . T-n, in terms of a position of an agent vehicle, such as using one or more sensors on the vehicle), feeding the localized map sequences into a deep reinforcement learning agent, which provides a direction of the next movement of the vehicle, evaluating the movement with a critic function and sending feedback signal to the deep reinforcement learning agent, and performing the movement by the vehicle and generating a new localized map. The new position of the vehicle may be compared with the selected destination and, if matched, the path guidance may be ended the history information updated. However, if the position of the vehicle is not matched with the selected destination, the localized map sequences may be updated with a new localized map, and functions of the adaptive path planning repeated. Such adaptive path planning, utilizing localized learning with global planning, provides for adaptiveness and generality facilitating application of the techniques with respect to a variety of dynamic environments.

Although the present disclosure and its advantages have been described in detail, it should be understood that various changes, substitutions and alterations can be made herein without departing from the spirit and scope of the design as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A method for adaptive path planning with respect to a dynamic environment, the method comprising:
determining, by global guidance logic of an adaptive path planning system, a planned path through the dynamic environment from a start location to a selected destination for an agent automated vehicle (AV); and
controlling, by local planning logic of the adaptive path planning system based at least in part on a deep reinforcement learning agent of the local planning logic utilizing localized map sequence information, dynamic interaction within the dynamic environment as the agent AV traverses at least a portion of the planned path.

2. The method of claim 1, wherein the determining the planned path comprises:
using a static searching algorithm to determine an initial global path connecting a start location with the selected destination.

3. The method of claim 2, wherein the static searching algorithm is selected from the group of searching algorithms consisting of Dijkstra, A*, D*, rapidly-exploring random tree (RRT), particle swarm optimization (PSO), and ant-colony.

4. The method of claim 2, wherein the determining the planned path further comprises:
using history information to revise the initial global path and provide a planned global path providing the planned path for traversal by the agent AV.

5. The method of claim 4, wherein the history information comprises path overlay information and pheromone information.

6. The method of claim 5, wherein the path overlay information comprises information regarding routes of moving obstacles, temporal information regarding movement, information regarding movement velocity, priority information with respect to moving obstacle movement, obstacle volume, pathway width, or combinations thereof.

7. The method of claim 5, wherein the pheromone information comprises information regarding observed recent obstacle movement information.

8. The method of claim 5, wherein the pheromone information corresponds to respective instances of the path overlay information.

9. The method of claim 8, wherein the pheromone information provides for the respective path overlay information decaying over time.

10. The method of claim 9, further comprising:
generating a localized map sequence comprising a plurality of localized maps corresponding to positions of the agent AV traversing the planned path, wherein each localized map of the localized map sequence comprises a sub-portion of the dynamic environment centered about a respective position of the agent AV.

11. The method of claim 10, wherein the controlling dynamic interaction within the dynamic environment comprises:
utilizing localized deep reinforcement learning (DRL) with respect to localized maps of the localized map sequence to determine actions for the agent AV within the dynamic environment.

12. The method of claim 11, wherein the localized DRL comprises a convolutional neural network (CNN) and recurrent neural network (RNN) configured to provide a modeled representation of the dynamic environment from the localized map sequence.

13. The method of claim 11, wherein the localized DRL comprises a DRL agent configured as a localized planner for directing interactions of the AV in the dynamic environment.

14. The method of claim 13, wherein the DRL agent comprises double deep Q learning (DDQN), Rainbow, Proximal Policy Optimization (PPO), Asynchronous Advantage Actor Critic (A3C), or a combination thereof.

15. The method of claim 14, wherein the dynamic environment comprises a multivehicle environment in which a plurality of moving obstacles are being operated.

16. The method of claim 15, wherein the multivehicle environment is an environment selected from the group consisting of a warehouse, a factory, and a city street grid.

17. A adaptive path planning system configured for providing adaptive path planning with respect to a dynamic environment, the adaptive path planning system comprising:
global guidance logic configured to determine a planned path through the dynamic environment from a start location to a selected destination for an agent automated vehicle (AV); and
local planning logic in communication with the global guidance logic and configured to control dynamic interaction within the dynamic environment, based at least in part on a deep reinforcement learning avert of the local planning logic utilizing localized map sequence information, as the agent AV traverses at least a portion of the planned path.

18. The adaptive path planning system of claim 17, wherein the global guidance logic and the local planning logic are executed by a control system implemented internally to the agent AV.

19. The adaptive path planning system of claim 18, wherein the control system comprises a control system selected from the group consisting of a vehicle control unit (VCU), an electronic control unit (ECU), and an on-board computer (OBC).

20. The adaptive path planning system of claim 19, wherein the global guidance logic comprises a static searching algorithm utilized to determine an initial global path connecting a start location with the selected destination.

21. The adaptive path planning system of claim 20, further comprising:
a database storing history information to revise the initial global path and provide a planned global path providing the planned path for traversal by the agent AV.

22. The adaptive path planning system of claim 21, wherein the history information comprises path overlay information and pheromone information.

23. The adaptive path planning system of claim 22, wherein the path overlay information comprises information regarding routes of moving obstacles, temporal information regarding movement, information regarding movement velocity, priority information with respect to moving obstacle movement, obstacle volume, pathway width, or combinations thereof.

24. The adaptive path planning system of claim 22, wherein the pheromone information corresponds to respective instances of the path overlay information, and wherein the pheromone information provides for the respective path overlay information decaying over time.

25. The adaptive path planning system of claim 24, further comprising:
localized map generation logic configured to generate a localized map sequence comprising a plurality of localized maps corresponding to positions of the agent AV traversing the planned path, wherein each localized map of the localized map sequence comprises a sub-portion of the dynamic environment centered about a respective position of the agent AV.

26. The adaptive path planning system of claim 25, wherein the local planning logic is configured to utilize localized deep reinforcement learning (DRL) with respect to localized maps of the localized map sequence to determine actions for the agent AV within the dynamic environment.

27. The adaptive path planning system of claim 26, wherein the localized DRL is configured to utilize a convolutional neural network (CNN) and recurrent neural network (RNN) to provide a modeled representation of the dynamic environment from the localized map sequence.

28. The adaptive path planning system of claim 26, wherein the localized DRL comprises a DRL agent configured as a localized planner for directing interactions of the AV in the dynamic environment.

29. The adaptive path planning system of claim 28, wherein the DRL agent comprises double deep Q learning (DDQN), Rainbow, Proximal Policy Optimization (PPO), Asynchronous Advantage Actor Critic (A3C), or a combination thereof.

30. A method for adaptive path planning with respect to a multivehicle environment, the method comprising:
defining a start and a destination of a path for an agent vehicle through the multivehicle environment;
planning, using a static searching algorithm, an initial path within the multivehicle environment connecting the start and the destination;
generating, from the initial path, a planned global guidance path using history information to revise the initial path;
generating a localized map sequence comprising a plurality of localized maps corresponding to positions of the agent vehicle traversing at least a portion of the planned global guidance path;
providing, by deep reinforcement learning agent using one or more localized map of the localized map sequence, a direction of a next movement of the agent vehicle; and
analyzing the movement of the agent vehicle and providing feedback to the deep reinforcement learning agent.

31. The method of claim 30, further comprising:
generating a new localized map for the localized map sequence for a position of the agent vehicle after movement by the agent vehicle based upon the direction provided by the deep reinforcement learning agent.

32. The method of claim 31, further comprising:
updating the localized map sequence after the movement of the agent vehicle by inserting the new localized map and deleting an oldest localized map of the localized map sequence.

33. The method of claim 31, further comprising:
determining if the agent vehicle has arrived at the destination, wherein if it is determined that the agent vehicle has not arrived at the destination updating the localized map sequence with the new localized map and repeating the providing the direction of a next movement of the agent vehicle and the analyzing the movement of the agent vehicle.

34. The method of claim 33, wherein the history information comprises path overlay information and pheromone information.
